(19) United States
(12) Patent Application Publication
(10) Pub. No.: US 2009/0030917 A1
(43) Pub. Date: Jan. 29, 2009

(54) MULTIMEDIA MESSAGING SERVICE-BASED DATABASE SYNCHRONIZATION

(76) Inventors: Chang Jie Guo, Beijing (CN); Song Song, Beijing (CN); Pei Sun, Beijing (CN)

Correspondence Address: HOFFMAN WARNICK LLC, 75 STATE ST, 14 FL, ALBANY, NY, 12207, US

(21) Appl. No.: 12/146,490

(22) Filed: Jun. 26, 2008

(30) Foreign Application Priority Data
Jul. 25, 2007 (CN) 200710139111

(51) Int. Cl. G06F 12/16; G06F 17/30

(52) U.S. Cl. 707/100; 707/203; 707/E17.044; 711/E12.103

(57) ABSTRACT

The present invention provides, in some embodiments, an MMS-based database synchronization method and system. The MMS-based database synchronization system comprises an MMS synchronization server, an MMS synchronization gateway and one or more MMS mobile terminals, wherein the MMS synchronization server is connected to an MMS center through the MMS synchronization gateway and conducts the delivery of the synchronization content in the database synchronization with the MMS mobile terminal through the MMS center.

### CROSS-REFERENCE TO RELATED APPLICATIONS

This application claims the benefit of co-pending Chinese Patent Application No. 200710139111, filed 25 Jul. 2007, which is hereby incorporated herein.

### FIELD OF THE INVENTION

The present invention relates to information processing technology, particularly to a system and method for implementing database synchronization between a server and a mobile terminal by using MMS (Multimedia Messaging Service).

### BACKGROUND OF THE INVENTION

Over the last years, small, mobile devices with data processing capabilities enjoy increasing popularity. So far, modern cellular phones don't have just a memory for storing phone numbers, but have become a personal information manager (PIM) with address book, agenda, email client, browser and much more functions. Furthermore, small computers in the size of calculators, so called handhelds, are getting commonly used.

As far as the above mentioned mobile devices are concerned, since they are not permanently connected to a network, an own copy of those databases which are related to the functions of the mobile devices and store related information is needed locally in each of the mobile devices. Moreover, for these databases, the copied version on each of the mobile device should be consistent with the version stored on the network. That is, modifications made on these databases on mobile devices should also be made on the network, and vice versa. Thus information related to these modifications should be exchanged between the mobile devices and the network periodically, so as to keep the consistency of the databases. This operation is called database synchronization.

A typical database synchronization architecture is shown in FIG. 1. In the architecture shown in FIG. 1, a server, for implementing the synchronization between a database at a network side and a corresponding database at a mobile terminal side, needs to build a LAN or VPN (Virtual Private Network) connection between it and the mobile terminal, and transmits mutually synchronization data by using the HTTP protocol via the LAN or VPN connection, thus implementing database synchronization.

However, different from desktop PCs, the mobile devices are not able to be always online due to network availability and battery power consumption. Therefore, any synchronization about database has to be postponed until the a mobile device becomes online and starts a database synchronization process between it and the server on its own initiative, even in the case that the databases on the server side are modified and need synchronization, because there is no efficient method for implementing a server initiated database synchronization so as to transfer up-to-date data to the mobile devices in time.

At present, one possible approach to resolve this issue is to use SMS (Short Messaging Service) as a notification means to trigger the mobile devices to become online and start a new database synchronization process actively between it and the server.

However, even if SMS is used as means for notifying a mobile terminal to start database synchronization, the architecture shown in FIG. 1 may still not always work in the real cases because of security and efficiency reasons. Because as shown in FIG. 1, if a certain enterprise wants to realize the function of database synchronization, it must first build a complicate and expensive VPN system and etc. to prevent the server from being viciously attacked, which for most enterprises is a very big burden undoubtedly. Furthermore, even for those enterprises owing VPN systems, the problem still exists. That is, because of limited performance and difficult maintenance, many mobile devices do not support VPN client. Thus in this case, such mobile devices can not realize remote database synchronization through VPN, even if they can become online via a wireless network.

Therefore, it is needed to design a secure, low cost and easy-to-build technology of database synchronization between a server and a mobile terminal, so as to solve these problems existed in the prior art.

### SUMMARY OF THE INVENTION

In view of the above problems in the prior art, the present invention is proposed and its object is to provide an MMS-based database synchronization method and system, so as to implement database synchronization between a sever and a mobile terminal in virtue of MMS, and allow the server to initiate a database synchronization process between it and the mobile terminal actively.

According to one aspect of the present invention, there is provided a Multimedia Messaging Service (MMS) based synchronization server, comprising: an MMS synchronization engine connected to a gateway connected to an MMS center, for initiating the deliver of a synchronization content to a certain mobile terminal through the MMS center when it is identified that there is needed to conduct database synchronization with the mobile terminal, and/or updating a local database in response to the synchronization content sent by the mobile terminal through the MMS center; and a synchronization control database for storing the control information needed during the database synchronization by the MMS synchronization engine.

According to another aspect of the present invention, there is provided a Multimedia Messaging Service (MMS) based synchronization gateway, comprising: an MMS synchronization gateway controller interfaced with a synchronization server, for receiving from the synchronization server a synchronization content to be sent to a mobile terminal, and/or sending to the synchronization server a synchronization content coming from the mobile terminal through the MMS center; an MMS packet encapsulating module for encapsulating the synchronization content received from the synchronization server by the MMS synchronization gateway controller and to be sent to the mobile terminal as an MMS synchronization package; an MMS package sending/receiving module connected to the MMS center via an MMS channel, for sending to the mobile terminal through the MMS center the MMS synchronization package generated by the MMS packet encapsulating module, and/or receiving from the MMS center the MMS synchronization package coming from the mobile terminal; and an MMS package parsing module for parsing the MMS synchronization package coming from the mobile terminal, received by the MMS package sending/receiving module from the MMS center, to obtain the synchronization content therein, and sending it to the synchronization server via the MMS synchronization gateway controller.

According to another aspect of the present invention, there is provided a Multimedia Messaging Service (MMS) based mobile terminal, comprising: an MMS client agent for sending and receiving an MMS message; and an MMS synchronization agent for initiating the deliver of a synchronization content to a synchronization server through an MMS center when it is identified that there is needed to conduct database synchronization with the synchronization server, and/or updating a local database in response to the MMS synchronization package for database synchronization sent from the synchronization server through the MMS center.

According to another aspect of the present invention, there is provided a Multimedia Messaging Service (MMS) based database synchronization method, comprising: encapsulating, by an initiator of database synchronization, the synchronization content needed to be delivered to a recipient of database synchronization for conducting database synchronization as an MMS synchronization package; and sending, by the initiator of database synchronization, the MMS synchronization package to the recipient of database synchronization through an MMS center.

According to another aspect of the present invention, there is provided a Multimedia Messaging Service (MMS) based database synchronization method, comprising: receiving, by a recipient of database synchronization, an MMS synchronization package containing a synchronization content from an initiator of database synchronization through an MMS center; and updating, by the recipient of database synchronization, a local database according to the synchronization content in the MMS synchronization package.

### BRIEF DESCRIPTION OF THE DRAWINGS

It is believed that the above features, advantages and objects of the present invention can be better understood from the following description of the particular embodiments of the present invention in conjunction with the drawings, in which:

FIG. 1 is a schematic diagram of a database synchronization architecture of prior art;

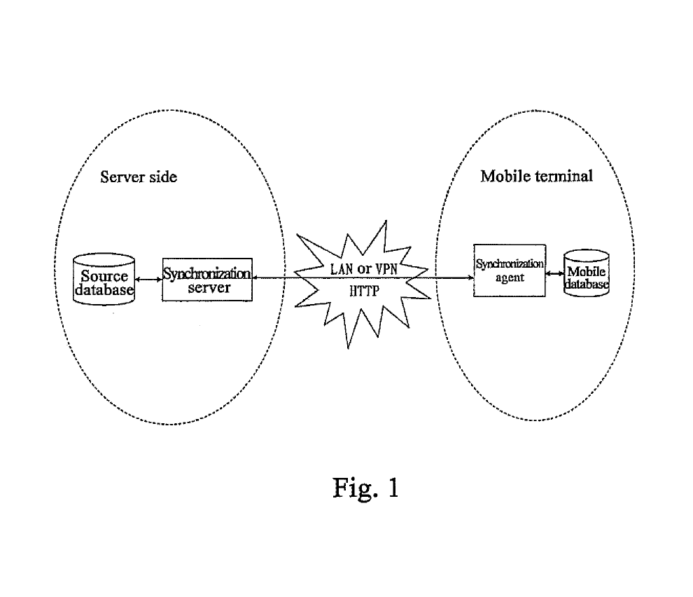

FIG. 2 is a schematic diagram of an MMS-based database synchronization system according to an embodiment of the present invention;

FIG. 3 is a block diagram of an MMS synchronization server according to an embodiment of the present invention;

FIG. 4 shows an exemplary data record table;

FIG. 5 is a block diagram of an MMS synchronization gateway according to an embodiment of the present invention;

FIG. 6 is a schematic diagram of the structure of a standard MMS message;

FIG. 7 is a schematic diagram of the structure of an MMS synchronization package according to an embodiment of the present invention;

FIG. 8 is a block diagram of an MMS mobile terminal according to an embodiment of the present invention; and

FIG. 9 is a flow chart of an MMS-based database synchronization method according to an embodiment of the present invention.

### DETAILED DESCRIPTION OF THE INVENTION

The core concept of the present invention is to enable a server to use MMS to implement database synchronization between it and a mobile terminal, thus enabling the server to use MMS to initiate a database synchronization process between it and the mobile terminal actively.

Therefore, in order to facilitate a complete understanding for the present invention, the concept of MMS will be introduced simply first before describing in detail the preferred embodiments of the present invention.

MMS is the abbreviation of Multimedia Messaging service, which is also usually called multimedia message. The most special characteristic is that it supports multimedia functions and can transfer contents and information with comprehensive functions.

Specifically, the MMS is a service for transferring information in various multimedia formats, such as text, image, sound, and data, by using the WAP wireless application protocol as a carrier under the support of a high speed transmission technology EDGE (Enhanced Data Rate for GSM Evolution) and the GPRS network.

In general, an MMS system mainly comprises the following network elements: an MMS terminal, an MMS relay server/MMS center, an MMS redirector and an MMS user database, etc. In addition, in order to coordinate with a multimedia messaging platform to provide an MMS, the support of WAP gateways, GSM/GPRS network resources and etc. are further needed

Wherein, MMS terminal: the MMS terminal implements the MMS through an MMS client agent. The MMS client agent is an application on the MMS terminal, which provides functions for a user to browse, edit and process MMS messages and operations of sending, receiving and deleting MMS messages. The MMS client agent supports MIME (Multipurpose Internet Mail Extension) standard, and through the definitions of various subtypes in MIME, an MMS message can contain content parts of different types, such as text, image, sound, and etc. MMS relay server/MMS center: the MMS center is the core of the whole MMS system, which processes, stores and forwards MMS messages. Meantime, the MMS center is also responsible for operations for MMS messages such as transfer between different MMS centers. In addition, the MMS center needs many connections to other networks. The MMS relay server is an IP interface of the MMS system, through which the MMS system is connected with various networks, thus realizing the support for various protocols.

MMS redirector: under the condition that the URL (Uniform Resource Locator) addresses of the MMS center are uniform across the network, this device is responsible for route query of the MMS center which a user belongs to. In addition, it further determines the MMS center which the user at transmitting side belongs to according to the MSISDN number of an HTTP package, and returns a redirection message to the WAP gateway, to allow the WAP gateway to forward the HTTP request to the MMS center.

MMS user database: it is used for storing user service information, service type, customized service information, and etc.

WAP gateway: the WAP gateway technically follows the MMS specification, so as to support the MMS. By setting up a data access channel between the MMS client agent and the MMS relay server through the WAP gateway, the operations of sending, receiving and notifying MMS messages are thus supported.

Taking an example that the MMS system sends MMS messages to a mobile phone, the MMS flow will be described simply.
1. When a multimedia message is sent to a mobile phone, the multimedia message is encoded in WSP protocol of WAP, and is sent to a WAP gateway through a wireless network.
2. The WAP gateway communicates with an MMS relay server with the HTTP protocol, and sends the content of the multimedia message to the MMS relay server.
3. The MMS relay server sends the multimedia message to an MMS center server, in which the content of the multimedia message is converted into a standard format of MIME, thus becomes an MMS message and is stored in a message memory.
4. The MMS center server conducts a data analysis, thus obtaining route information, user terminal information and etc.
5. Routing is conducted according to the MSISDN number of the called user, and the MMS relay server communicates with the outside though the WAP gateway, thus sending the MMS message to the mobile phone.

MMS has been broadly accepted as a killer application in the 2.5G and 3G mobile communication market in terms of its simplicity, accessibility and ease-of-use. Growing with the broad deployment of 2.5G and 3G mobile networks globally, MMS is already a worldwide available service.

MMS' main advantages of “storage forward” and “data push” function as well as the secure data transmitting channel makes it possible that the mobile devices do not have to be always online and a reliable message delivery is guaranteed. The inventors of the present invention find through research that these characteristics of MMS allow MMS to be an ideal mechanism and infrastructure for the implementation of database synchronization. If MMS is used, not only server initiated synchronization will become possible, but also the reduction of the cost and the improvement of overall performance and reliability will become possible.

The preferred embodiments of the present invention will be detailed below in conjunction with the drawings. First an MMS-based database synchronization system of the present invention will be described.

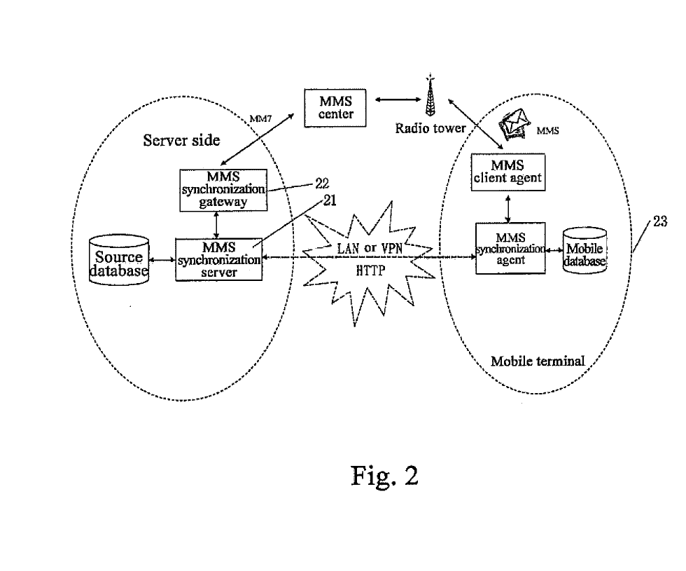

FIG. 2 is a schematic diagram of an MMS-based database synchronization system according to an embodiment of the present invention. As shown in FIG. 2, the MMS-based database synchronization system of the present embodiment comprises an MMS synchronization server 21 and an MMS synchronization gateway 22 on a server side, one or more MMS mobile terminals 23 on a client side, and etc.

Wherein, the MMS synchronization server 21 is mainly used for the management and maintenance of a synchronization database at the network side. The MMS synchronization server 21 interfaces with the MMS synchronization gateway 22, and thus can conduct database synchronization with the MMS mobile terminal 23 by using the MMS system. In addition, the MMS synchronization server 21 can also be connected to the MMS mobile terminal 23 through a traditional network such as a mobile device plug or a wireless network card. In this case, the MMS synchronization server 21 can conduct traditional database synchronization with the MMS mobile terminal 23. Specifically, when identifying that the database synchronization is needed, the MMS synchronization server 21 first detects an available synchronization channel, and, according to the predetermined channel selection policy, starts a delivery of the synchronization content to the corresponding MMS mobile terminal 23 via the MMS synchronization gateway 22 and the MMS center or starts a direct delivery of the synchronization content to the corresponding MMS mobile terminal 23 through a traditional network such as a mobile device plug or a wireless network card. In addition, the MMS synchronization server 21 further updates the local database in response to the database synchronization initiated by the MMS mobile terminal 23.

In this embodiment, the MMS synchronization gateway 22 is a kind of MMS VAS (Value-Added Services) application, which connects with the telecom carrier's MMS center via a standard MM7 interface. Thus, one key function of the MMS synchronization gateway 22 is to encapsulate the synchronization content to be synchronized from the MMS synchronization server 21 into an MMS synchronization package, and send the MMS synchronization package to an MMS mobile terminal 23 through the MMS center according to the address of the MMS mobile terminal 23 instructed by the MMS synchronization server 21; and to parse the MMS synchronization package embedded with the synchronization content received by the MMS center from the MMS mobile terminal 23 to obtain the synchronization content therein and send it to the MMS synchronization server 21. That is, the key function of the MMS synchronization gateway 22 is to provide an access from the MMS synchronization server 21 to the MMS system so as to implement database synchronization by using MMS.

On the MMS mobile terminal 23 side, the MMS client agent receives the MMS synchronization package embedded with the synchronization content, just like the normal MMS message, from the MMS center, and the MMS synchronization agent updates the local mobile database according to the MMS synchronization packet. In addition, the MMS mobile terminal 23 can also be connected to the MMS synchronization server 21 through a mobile device plug or a wireless network card. In this case the MMS mobile terminal 23 can further conduct traditional database synchronization with the MMS synchronization server 21 through a traditional network such as a mobile device plug or a wireless network card. Thus, when at the MMS mobile terminal 23 side it is identified that the database synchronization is needed, according to the available synchronization channel, the MMS mobile terminal 23 starts a delivery of the synchronization content to the MMS synchronization server 21 through the MMS center or starts a direct deliver of the synchronization content to the MMS synchronization server 21 via the traditional network.

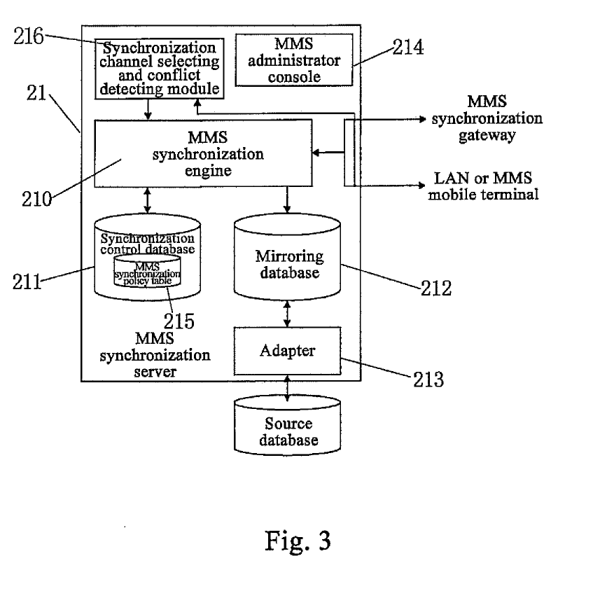

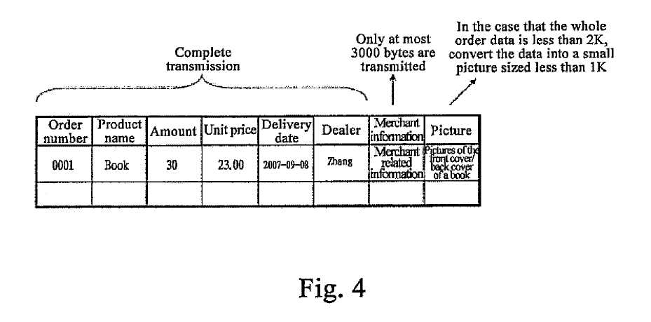

The MMS synchronization server 21 in the above system in FIG. 2 will be described in detail in conjunction with FIGS. 3-4.

FIG. 3 is a block diagram of an MMS synchronization server according to an embodiment of the present invention. As shown in FIG. 3, the MMS synchronization server 21 of the present embodiment comprises an MMS synchronization engine 210, a synchronization control database 211, a mirroring database 212, an adapter 213, an MMS administrator console 214 and a channel selecting and conflict detecting module 216.

Wherein, the mirroring database 212 is a mirror image of a source database outside the MMS synchronization server 21, shown in FIG. 3, which interfaces with the source database via the adapter 213 to obtain data therefrom, so that the MMS synchronization engine 210 sends the data to the corresponding MMS mobile terminal 23 if necessary to conduct database synchronization. In addition, in the course of the database synchronization initiated by the MMS mobile terminal 23, after the MMS synchronization engine 210 updates the data in the mirroring database 212 according to the synchronization content from the MMS mobile terminal 23, the mirroring database 212 writes back the data into the source database via the adapter 213. That is, the effect of the mirroring database 212 is to act as the mirror image of the source database, so as to make the MMS synchronization engine 210 not operate the source database, thus improving the speed and security of data synchronization.

The synchronization control database 211 is used to store control information needed in the database synchronization between the MMS synchronization server 21 and the corresponding MMS mobile terminal 23. For example, the control information comprises the manner and time of initiating the database synchronization and the address of the MMS mobile terminal 23.

In addition, in the synchronization control database 211, an MMS synchronization policy table 215 is further included, which is used to record the identification information needed in the MMS-based database synchronization between the MMS synchronization server 21 and the MMS mobile terminal 23, and the synchronization content packaging policy applied in the MMS-based database synchronization initiated by the MMS synchronization server 21.

In a preferred embodiment, the above mentioned identification information can be a device ID, such as a phone number, assigned to the MMS synchronization server 21 by the MMS center or the mobile phone operator.

In a preferred embodiment, the above mentioned synchronization content packaging policy can be a fine-granularity synchronization content packaging policy for prescribing the selection manner by the MMS synchronization engine 210 for the synchronization content to be sent to a certain MMS mobile terminal 23, preset with respect to the MMS mobile terminal 23 in the MMS synchronization policy table 215. The fine-granularity synchronization content packaging policy will be described in detail hereinafter.

The MMS synchronization engine 210 can interface with the MMS synchronization gateway 22 or be connected with the MMS mobile terminal 23 via a mobile device plug or a wireless network card, etc., and monitors the source database through the mirroring database 212 to identify whether the data therein has been modified. In the case of identifying the data in the source database has been modified, the MMS synchronization engine 210 initiates the MMS-based database synchronization between it and the corresponding MMS mobile terminal 23 or the traditional database synchronization through a traditional connection.

Specifically, in the case that the MMS synchronization engine 210 identifies the data in the source database has been modified through the mirroring database 212, the MMS synchronization engine 210 acquires corresponding control information from the synchronization control database 211, such as the address of a MMS mobile terminal 23 related to the modified data. Next, the MMS synchronization engine 210 instructs the synchronization channel selecting and conflict detecting module 216 to detect synchronization channels, thus selecting an available synchronization channel between it and the MMS mobile terminal 23.

The synchronization channel selecting and conflict detecting module 216 detects whether the MMS synchronization server 21 is connected with the corresponding MMS mobile terminal 23 through a traditional network such as a mobile device plug or a wireless network card, according to the instruction of the MMS synchronization engine 210. If not, then a synchronization channel via MMS is selected; otherwise, in the case that a traditional synchronization channel via a mobile device plug or a wireless network card and a synchronization channel via MMS are both available, the synchronization channel selecting and conflict detecting module 216 can select one of the synchronization channels therefrom according to a predefined channel selection policy.

Next, in the case of the traditional synchronization channel, the MMS synchronization engine 210 acquires the synchronization content to be transferred from the mirroring database 212, and starts the deliver of the synchronization content to the corresponding MMS mobile terminal 23 via a traditional network such as a mobile device plug or a wireless network card, thus implementing the traditional database synchronization.

In addition, in the case of conducting the MMS-based database synchronization with the MMS synchronization channel, the MMS synchronization engine 210 acquires the synchronization content packaging policy related to the MMS mobile terminal 23 from the MMS synchronization policy table 215, and acquires the synchronization content to be transferred to the MMS synchronization gateway 22 for packaging from the mirroring database 212 according to the policy. Then, the MMS synchronization engine 210 transfers the acquired address of the MMS mobile terminal 23, the synchronization content to be transferred, and the device ID of the MMS synchronization server 21 together to the MMS synchronization gateway 22, thus realizing the MMS-based database synchronization.

In addition, the MMS synchronization engine 210 further updates the data in the mirroring database 212, thus writing it back into the source database, in response to the synchronization content sent by the MMS mobile terminal 23 through the MMS center and the MMS synchronization gateway 22 or the synchronization content sent via the traditional network such as the mobile device plug or the wireless network card, etc.

In addition, in the case that a plurality of potential synchronization channels coexist, when conducting database synchronization with the corresponding MMS mobile terminal 23, at the MMS synchronization server 21 side, it is needed to detect and handle the synchronization conflict resulted from the coexistence of the plurality of potential channels. For example, after a certain MMS mobile terminal 23 sends an MMS synchronization package to the MMS synchronization server 21, the MMS mobile terminal 23 is connected to the MMS synchronization server 21 via a mobile device plug at a site where a mobile device plug is available. In this case, if at this moment the MMS synchronization package sent out previously has not reached the MMS synchronization server 21, then it is possible to conflict with the database synchronization conducted subsequently between the MMS synchronization server 21 and the MMS mobile terminal 23 through the network. To this end, when the MMS synchronization server 21 is conducting the database synchronization with a certain MMS mobile terminal 23, besides detecting and selecting the available synchronization channel, the synchronization channel selecting and conflict detecting module 216 further needs to detect whether there is any conflict between the database synchronization and the previous database synchronization, and handle the conflict in turn.

In a preferred embodiment, the above mentioned synchronization content to be transferred may be data or command script to be synchronized between the MMS synchronization server 21 and the MMS mobile terminal 23.

In addition, the MMS administrator console 214 is an administrator interface in the MMS synchronization server 21. With the MMS administrator console 214, the administrator can perform such information setting as MMS related system configuration and data subscription on the MMS synchronization server 21. In addition, the administrator can further set control information for database synchronization in the synchronization control database 211 with the MMS administrator console 214, and set the corresponding synchronization content packaging policy in the MMS policy table 215 with respect to a certain MMS mobile terminal 23, such as the above mentioned fine-granularity synchronization content packaging policy.

The above mentioned fine-granularity synchronization content packaging policy will be described in detail below.

As mentioned above, in the present embodiment, the MMS synchronization server 21 can carry the synchronization content to be synchronized by using an MMS system. As well known by a person skilled in the art, the MMS system transmits data based on a wireless data channel (mainly GPRS). Compared to the traditional wired network, the wireless data channel has such characteristics as a low transmission rate, a high transmission error rate. In the traditional transmission of synchronization data based on a wired network, all the synchronization data are treated equally to be packaged and transferred to a mobile terminal without considering the size, type and priority of the synchronization data. But as far as a wireless network is concerned, if such packaging method is still used simply, then the following disadvantageous cases may be induced:

When the data amount of the synchronization content is too large, a very large MMS synchronization package will be generated, which will take a very long time and very high transmission cost for the MMS mobile terminal receiving it to complete the synchronization. In an extreme case, the MMS mobile terminal is even unable to complete the downloading of the large MMS synchronization package.

In many cases, the data fields resulting in the giant MMS synchronization package are not the data most needed by the MMS mobile terminal. For example, in the data of an order, the most critical information of a product such as product name, amount, price, serial number, often account only for a very small data amount, while some uncritical fields such as product pictures will account for a great data amount. If they are treated equally to simply perform packaging, then it is possible for the whole order to generate a transmission delay or be even unable to be downloaded because the data amount to be synchronized is too large due to the picture which is not very important information.

With respect to the above problem, in a preferred embodiment of the present invention, the fine-granularity synchronization content packaging mechanism is proposed, which allows the MMS synchronization engine 210 to package the synchronization content discriminatively according to the types, priorities and rules of various fields, thus enabling the acquired MMS synchronization package to be more adaptive to the MMS data transmission channel.

Describing by taking a specific example, FIG. 4 shows an exemplary data record table. As shown in FIG. 4, an order record therein comprises very important and indispensable fields such as order number, product name, amount, unit price, delivery date, dealer, and also contains a comparatively important merchant information field and an auxiliary picture field.

With respect to the above circumstance, according to the fine-granularity synchronization content packaging mechanism proposed in the present embodiment, the following fine-granularity synchronization content packaging policies can be defined:

For the very important fields, all data are packaged and synchronized integrally;

For the merchant information, at most the content with no more than 3000 bytes is packaged and synchronized;

For an auxiliary picture, in the case that the whole order data to be transferred is less than 2K, the picture is changed into a small picture sized less than 1K by conversion for synchronization; otherwise the field is abandoned directly.

The above mentioned fine-granularity synchronization content packaging mechanism proposed in the present embodiment can not only control the whole size of the content to be synchronized, but also embody the priorities of different fields, thus ensuring the timely synchronization of important data.

Correspondingly, based on the proposed fine-granularity synchronization content packaging mechanism, in the MMS synchronization policy table 215 of the present embodiment, the fine-granularity synchronization content packaging policy of each target MMS mobile terminal 23 can be recorded and managed in the form of the fine-granularity synchronization content packaging policy table as shown in the following Table 1:

TABLE 1
MainDataSourcePolicy

| | | | |
|---|---|---|---|
| MainDSID | DeviceID | TargetDataSource | RecordLevelPolicySet |

Table 1 manages the fine-granularity synchronization content packaging policy of each MMS mobile terminal 23 at record level, and as shown above, it mainly comprises the following fields:

MainDSID: It is a record ID for uniquely identifying the fine-granularity synchronization content packaging policy record of a certain data source of an MMS mobile terminal 23, which can be numbers, characters, and etc.;

DeviceID: It is used for uniquely identifying a target MMS mobile terminal 23. It can be the IMEI or mobile phone number of the MMS mobile terminal 23, and can also be another tag that can identify uniquely the MMS mobile terminal 23;

TargetDataSource: It is the target data source needed for synchronization, for identifying the data sources to be synchronized, such as table, view and etc.; and

RecordLevelPolicySet: It is a set of fine-granularity synchronization content packaging policies oriented to the data source record level. For example, the maximum data transmission amount of each record is 3K; only records with the order price of more than 3000 dollars are synchronized; and the maximum number of the records contained in each MMS synchronization package is 20, and etc.

In addition, in another embodiment, in the MMS synchronization policy table 215, the fine-granularity synchronization content packaging policy of each target MMS mobile terminal 23 may be recorded and managed in the form of the fine-granularity synchronization content packaging policy table as shown in the following Table 2:

TABLE 2
DataFieldPRIPolicy

| | | | |
|---|---|---|---|
| DataFieldID | MainDSID | TargetDataField | DataFieldLevelPolicySet |

Table 2 manages the fine-granularity synchronization content packaging policy of each MMS mobile terminal 23 in a field level, and as shown above it mainly contains the following fields:

DataFieldID: It is a record ID for uniquely identifying the fine-granularity synchronization content packaging policy record of a certain field of a certain data source of an MMS mobile terminal 23, which can be numbers, characters, and etc.;

MainDSID: It is used for uniquely identifying the fine-granularity synchronization content packaging policy record of a certain data source of an MMS mobile terminal 23;

TargetDataField: It is a target data field needed for synchronization; and

DataFieldLevelPolicySet: It is a set of fine-granularity synchronization content packaging policies oriented to the data field level. For example, the field should be synchronized completely; only the contents with no more than 2000 bytes of the field are transmitted; and the field is not transmitted in the case that the record size is greater than 2000 bytes, and etc. The above is the detailed description for the MMS synchronization server of the present embodiment.

In the present embodiment, while it is described that the MMS synchronization engine 210 initiates the MMS-based database synchronization according to the case of the modification of data, it is not limited to this. For example, the MMS-based database synchronization between an MMS synchronization server and the corresponding MMS mobile terminal can be initiated in any way that a person skilled in the art can conceive such as periodically or based on a predetermined time table.

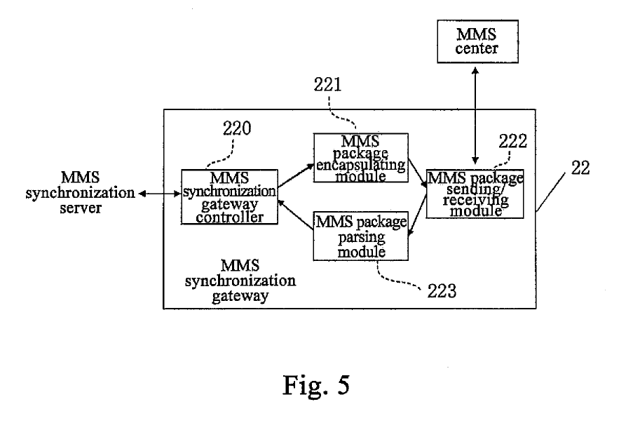

Next the MMS synchronization gateway 22 in the above system of FIG. 2 will be described in detail in conjunction with FIGS. 5-7.

FIG. 5 is a block diagram of an MMS synchronization gateway according to an embodiment of the present invention. As shown in FIG. 5, the MMS synchronization gateway 22 of the present embodiment comprises an MMS synchronization gateway controller 220, an MMS package encapsulating module 221, an MMS package sending/receiving module 222 and an MMS package parsing module 223.

Wherein, the MMS synchronization gateway controller 220 is connected to the MMS synchronization sever 21 for receiving from the MMS synchronization sever 21 the synchronization content to be transferred to the corresponding MMS mobile terminal 23 through the MMS center, the address of the MMS mobile terminal 23 and the identification information of the MMS synchronization sever 21 itself, and sending such information to the MMS package encapsulating module 221. In addition, the MMS synchronization gateway controller 220 further sends to the MMS synchronization sever 21 the synchronization content and corresponding device identification information which come from the MMS package parsing module 223 and are received from the MMS center by the MMS package sending/receiving module 222.

The MMS package encapsulating module 221 is used for encapsulating the synchronization content, which is received by the MMS synchronization gateway controller 220 from the MMS synchronization sever 21 and is to be transferred to the corresponding MMS mobile terminal 23 through the MMS center, into an MMS synchronization package, and transfer it to the MMS package sending/receiving module 222.

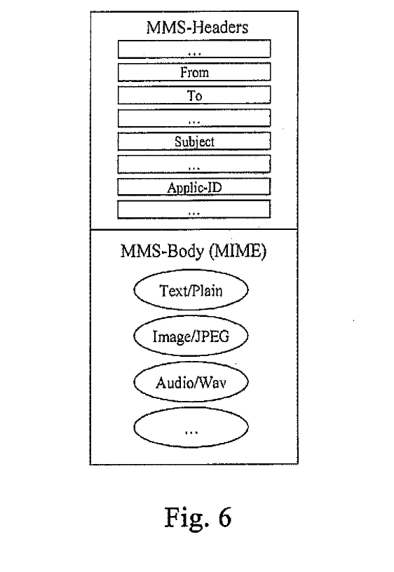

FIG. 6 is a schematic diagram of the structure of a standard MMS message. As shown in FIG. 6, the standard MMS message comprises two parts: an MMS header (MMS-Header) and an MMS body (MMS-Body (MIME)). Wherein, the MMS header is composed of fields such as From, To, Subject, Applic ID, and etc. The MMS body mainly carries the message content, which comprises several content parts with different content types such as Text/Plain, Image/JPEG and Audio/Wav.

In the present embodiment, as the structure of the MMS synchronization package, the structure of the MMS message specially defined based on the above standard MMS message is used.

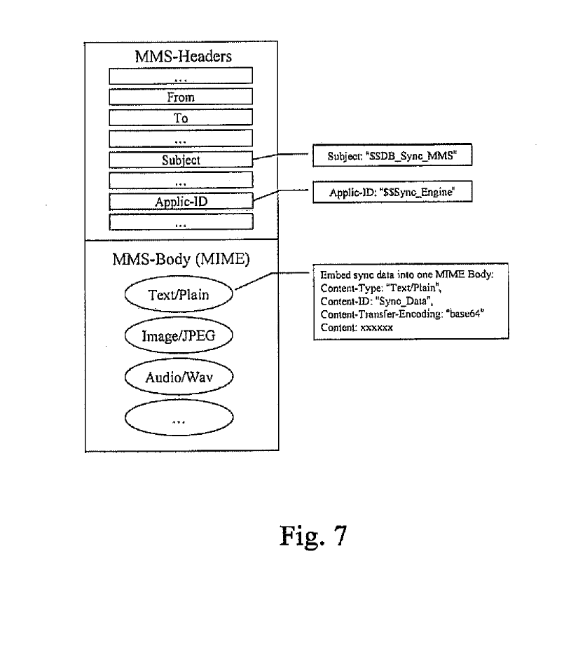

FIG. 7 is a schematic diagram of the structure of an MMS synchronization package according to an embodiment of the present invention. As shown in FIG. 7, the MMS synchronization package of the present embodiment comprises two parts: an MMS header (MMS-Header) and an MMS body (MMS-Body (MIME)). Wherein, the MMS header is composed of fields such as From, To, Subject, Applic ID and etc.

From: the address of the MMS synchronization server 21, such as the identification information like the mobile phone number assigned by the MMS center or the mobile phone operator;

To: the address of the MMS mobile terminal 23 as recipient, such as the phone number of the MMS mobile terminal 23;

Subject: a special text for identifying the MMS message is an MMS synchronization package for database synchronization, such as “$$DB_Sync_MMS”; and

Applic ID: the name of the application for processing the received MMS synchronization package, such as “Sync_Engine” for identifying the MMS synchronization engine in the MMS mobile terminal 23.

In addition, the MMS body mainly carries the synchronization content to be synchronized, which comprises several content parts with different content types such as Text/Plain, Image/JPEG and Audio/Wav.

Wherein, by taking the part of Text/Plain as an example, as shown in FIG. 7, in the present embodiment, at least following two attributes are defined to identify the content of the part is one for database synchronization:

Content-Type: its value “Text/Plain” indicates the content part subsequent to the attribute is of text type; and

Content-ID: its value “Sync_Data” indicates that the MMS message is an MMS synchronization package.

Thus the synchronization data and command scripts of text type can be encapsulated into the content part of the Text/Plain part as synchronization contents. For the content parts of other types, they may be deduced by analogy.

In the case of the structure of the MMS synchronization package shown in FIG. 7, the process that the MMS package encapsulating module 221 generates an MMS synchronization package according to the synchronization content, the address of the target MMS mobile terminal 23 and the identification information of the MMS synchronization sever 21 itself received by the MMS synchronization gateway controller 220 from the MMS synchronization sever 21 is as follows: first the type of the synchronization content is determined and inserted into the corresponding type of content part of the message body of an MMS message, and the attribute Content-ID is used to indicate the content is a synchronization content; next, the identification information of the MMS synchronization sever 21 and the address of the target MMS mobile terminal 23 are inserted into the fields of source address and destination address of the header part of the MMS message, respectively; and finally, at the subject field of the header part of the MMS message, the MMS message is indicated as an MMS synchronization package. It should be pointed out that, the above process of generating an MMS synchronization package is only exemplary and the sequence of the steps therein can be varied.

In addition, in the present embodiment, in addition to the above simple packaging operations, the following is further considered: although the MMS provided by the telecom carrier is relatively stable and reliable in most cases, the MMS protocol itself does not guarantee absolute reliable transmission, which is embodied in the following two aspects:

The MMS message package might be lost;

The receiving sequence of different MMS message packages cannot be guaranteed, i.e. the MMS message package first sent may be received last.

The above features of MMS is very disadvantageous for database synchronization. For the same data source of the same MMS mobile terminal 23, the synchronization data contained in different MMS synchronization packages are generally time dependent therebetween. The loss of MMS synchronization packages and the confusion of sequence will result in an exception of the data synchronization process.

Therefore, in the present embodiment, in order to solve the above problems, the MMS package encapsulating module 221 further assigns a synchronization number to each of all generated MMS synchronization packages with respect to the same data source of an MMS mobile terminal 23. The synchronization numbers of these MMS messages increment in time sequence without break, for identifying the consecutive sequence and the continuity among these related MMS synchronization packages, so as to allow the MMS mobile terminal 23 receiving them to determine whether the related MMS synchronization packages received by it are continuous according to the synchronization numbers, thus determining its local database synchronization status.

Next, the MMS package sending/receiving module 222 connected with the MMS center via an MM7 channel sends the MMS synchronization package generated by the MMS package encapsulating module 221 via the MM7 channel to the MMS center, and to the target MMS mobile terminal 23 through the MMS center. In addition, the MMS package sending/receiving module 222 further receives from the MMS center via the MM7 channel the MMS synchronization package coming from the MMS mobile terminal 23, and sends it to the MMS package parsing module 223.

The MMS package parsing module 223 parses the MMS synchronization package received by the MMS package sending/receiving module 222, so as to acquire the synchronization content and the corresponding device information therein, and sends them to the MMS synchronization sever 21 through the MMS synchronization gateway controller 220.

Specifically, the process that the MMS package parsing module 223 parses the received MMS synchronization package is as follows: first a synchronization content is parsed out of the message body part of the MMS synchronization package; then a source address and a destination address are parsed out of the message header part of the MMS synchronization package; and finally the above synchronization content, source address, and destination address are sent to the MMS synchronization gateway controller 220, respectively.

Thus, the MMS synchronization sever 21 updates the corresponding data in the local database according to the source address and the synchronization content.

The above is a detailed description for the MMS synchronization gateway of the present embodiment.

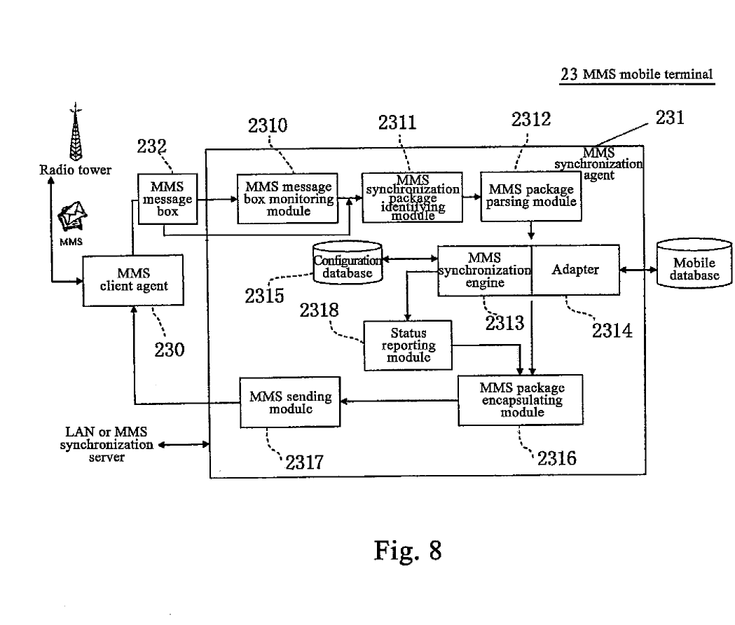

The MMS mobile terminal 23 in the above system of FIG. 2 will be described in detail in conjunction with FIG. 8.

FIG. 8 is a block diagram of an MMS mobile terminal according to an embodiment of the present invention. As shown in FIG. 8, the MMS mobile terminal 23 of the present embodiment comprises an MMS client agent 230 and an MMS synchronization agent 231.

That is, the MMS mobile terminal 23 of the present embodiment is an MMS-enabled mobile terminal. For such a mobile terminal, the MMS client agent 230 is a standard MMS sending/receiving module resident therein for sending and receiving MMS messages, and storing all the received MMS messages in an MMS message box 232 of the MMS mobile terminal 23. In addition, since the structure of the MMS synchronization package embedded with synchronization data or command script is based on a standard MMS message, the MMS client agent 230 can treat the MMS synchronization package as a normal MMS message.

In addition, the MMS synchronization agent 231 is a module in the MMS mobile terminal 23 for implementing database synchronization. On one hand, it is used for monitoring the local database to identify whether the data therein has been modified. In the case that it is identified that the local database has been modified, the MMS synchronization agent 231 initiates the deliver of a synchronization content to the MMS synchronization sever 21 through the MMS center. On the other hand, the MMS synchronization agent 231 further updates the local database in response to the MMS synchronization package for database synchronization received by the MMS client agent 230 from the MMS center.

Specifically, as shown in FIG. 8, the MMS synchronization agent 231 further comprises an MMS message box monitoring module 2310, an MMS synchronization package identifying module 2311, an MMS package parsing module 2312, an MMS synchronization engine 2313, an adapter 2314, a configuration database 2315, an MMS package encapsulating module 2316, an MMS sending module 2317, and a status reporting module 2318.

Wherein the MMS message box monitoring module 2310 is used for examining the MMS message box 232 to check whether there is a new message. And in the case that a new message is found, the MMS message box monitoring module 2310 notifies the MMS synchronization package identifying module 2311.

The MMS synchronization package identifying module 2311 is used for identifying whether the new MMS message in the MMS message box 232 is an MMS synchronization package when receiving the notification from the MMS message box monitoring module 23 10. Since the MMS mobile terminal 23 is not dedicated to database synchronization like the MMS synchronization sever 21, and instead is used as a personal information management tool for a user, the MMS message received by it may be miscellaneous. So, it is needed to identify whether the received new MMS message is an MMS synchronization package for database synchronization. The identification can be implemented by checking the subject field of the header part of the MMS message.

In the case that it is identified that the new MMS message is an MMS synchronization package, the MMS synchronization package identifying module 2311 sends the MMS synchronization package to the MMS package parsing module 2312.

The MMS package parsing module 2312 parses out the synchronization content embedded in the identified MMS synchronization package. Specifically, the MMS package parsing module 2312 parses out the synchronization content from the message body part of the MMS synchronization package. Further, in the case that there is a plurality of MMS synchronization servers, the MMS package parsing module 2312 further parses out the source address from the message header part of the MMS synchronization package to identify the source initiating database synchronization.

After parsing out the content in the MMS synchronization package, the MMS package parsing module 2312 sends it to the MMS synchronization engine 2313. The MMS synchronization engine 2313 interfaces with a local mobile database through the adapter 2314, for updating the mobile database according to the synchronization content received from the MMS package parsing module 2312.

In addition, the MMS synchronization engine 2313 further monitors the mobile database to identify whether the data therein has been actively modified by a user locally in addition to being synchronized. In the case that it is identified that the data in the mobile database has been modified by the user, the MMS synchronization engine 2313 initiates an MMS-based database synchronization between it and the MMS synchronization sever 21.

Specifically, in the case that it is identified that the data in the mobile database has been modified by the user, the MMS synchronization engine 2313 acquires the corresponding configuration data from the configuration database 2315, such as the address of the MMS synchronization sever 21 and the its own address. In addition, the MMS synchronization engine 2313 acquires the synchronization content to be transferred to the MMS synchronization sever 21 from the mobile database. Then the MMS synchronization engine 2313 sends the acquired address of the MMS synchronization sever 21, the synchronization content to be transferred, and the address of the MMS mobile terminal 23 together to the MMS package encapsulating module 2316.

In addition, it should be pointed out that, generally since the local data amount of an mobile terminal is small, the generated MMS synchronization package will not be large. So in the present embodiment, at the MMS mobile terminal 23 side, the above mentioned fine-granularity synchronization content packaging policy may not be applied in the acquisition and transmission of the synchronization content, instead, the MMS synchronization engine 2313 directly acquires all the contents to be synchronized. But it is not limited to this, and in order to ensure the correctness of database synchronization reliably, such a fine-granularity synchronization content packaging policy can be preset in the configuration database 2315, thus allowing the MMS synchronization engine 2313 to selectively acquire the synchronization content to be transferred according to the policy for encapsulation and transmission.

The MMS package encapsulating module 2316 encapsulates the above address of the MMS synchronization sever 21, synchronization content and address of the MMS mobile terminal 23 as an MMS synchronization package, and sends it to the MMS sending module 2317. Specifically, the MMS package encapsulating module 2316 first determines the type of the synchronization content and inserts it into the corresponding type of content part of the message body of the MMS message, and indicates that the content is the synchronization content with the attribute of Content-ID; next, inserts the address of the MMS mobile terminal 23 and the address of the MMS synchronization sever 21 into the source address field and the destination address field of the header part of the MMS message, respectively; and finally, indicates the MMS message is an MMS synchronization package in the subject field of the header part of the MMS message.

It should be pointed out that the above process of generating an MMS synchronization package is only exemplary and the sequence of the steps therein can be varied.

In addition, the MMS package encapsulating module 2316 may also assign a synchronization number to each of all the generated MMS synchronization packages with respect to the same data source in the MMS mobile terminal 23, for identifying the sequence and continuity among the related MMS synchronization packages, so as to allow the MMS synchronization sever 21 receiving them to determine whether the related MMS synchronization packages it receives are continuous according to the synchronization numbers, thus determining its local database synchronization status.

The MMS sending module 2317 is used for sending the MMS synchronization package generated by the MMS package encapsulating module 2316 to the MMS center, which sends it to the MMS synchronization sever 21 in turn.

The status reporting module 2318 is used for generating a synchronization status report for reporting to the MMS mobile terminal 23 the local database synchronization status. The synchronization status report is encapsulated as a synchronization status report package by the MMS package encapsulating module 2316 and is sent to the MMS synchronization sever 21 through the MMS center.

As described above, the MMS synchronization package sent from the MMS synchronization sever 21 can have a synchronization number, for identifying the sequence and continuity between the MMS synchronization package and other related MMS synchronization packages sent to the MMS mobile terminal 23. In this case, the MMS synchronization engine 2313 in the MMS mobile terminal 23 determines whether the local database synchronization status is normal according to the synchronization number.

Specifically, if the synchronization number of the MMS synchronization package is continuous with the synchronization number of a recently received MMS synchronization package (corresponding to the same data source), then (1) the MMS synchronization engine 2313 conducts database synchronization updating; (2) the status reporting module 2318 returns an acknowledge status report to the MMS synchronization sever 21, in which it is contained the synchronization number of the MMS synchronization package; and (3) after receiving the acknowledge status report, the MMS synchronization sever 21 stores the synchronization number encapsulated therein for further data synchronization updating.

In addition, if the synchronization number of the MMS synchronization package is not continuous with the synchronization number of a recently received MMS synchronization package (corresponding to the same data source), then (1) the MMS synchronization package is buffered at the MMS mobile terminal 23 side; (2) a preset time interval is waited, and if a new MMS synchronization package is received in this period and makes all the received related MMS synchronization packages keep continuous in the synchronization numbers, then the operation follows the above normal flow; otherwise (3) the status reporting module 2318 returns an exception status report to the MMS synchronization sever 21, in which it is contained the synchronization number of the recently received continuous MMS synchronization package and a synchronization number list of all the received discontinuous MMS synchronization packages; and (4) after receiving the exception status report, the MMS synchronization sever 21 resends the lacked MMS synchronization package to the MMS mobile terminal 23 so as to guarantee the integrity of the synchronization data.

In addition, although not shown in FIG. 8, the MMS mobile terminal 23 may further comprise a synchronization channel selecting and conflict detecting module for detecting and selecting an available synchronization channel and/or detecting and solving a synchronization conflict due to a plurality of available synchronization channels when the MMS mobile terminal 23 needs to initiate database synchronization between it and the MMS synchronization server 21. The above is a detailed description of the MMS-based database synchronization system of the present embodiment. Because the MMS is used for implementing database synchronization between the MMS synchronization server and the MMS mobile terminal, the MMS-based database synchronization system of the present embodiment enables the MMS mobile terminal to implement the database synchronization between it and the MMS synchronization server through a simple connection between the MMS synchronization server and the MMS center, without being connected directly to the MMS synchronization server. And in the present embodiment, the MMS synchronization server is further allowed to initiate a database synchronization process between it and the MMS mobile terminal actively.

Under the same inventive concept, the present invention proposes an MMS-based database synchronization method. The MMS-based database synchronization method will be described in detail below in conjunction with the figure.

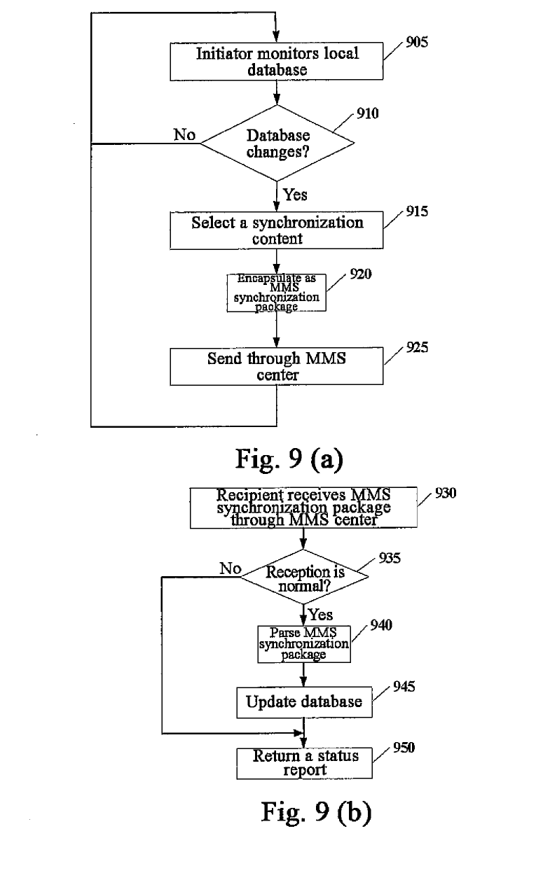

FIG. 9 is a flow chart of the MMS-based database synchronization method according to an embodiment of the present invention. Wherein, FIG. 9(a) is a flow executed by the party of a synchronization server and a mobile terminal as the initiator of database synchronization in the MMS-based database synchronization method 900 according to the embodiment, and FIG. 9(b) is a flow executed by the party of a synchronization server and a mobile terminal as the recipient of database synchronization.

As shown in FIG. 9(a), at the side of the initiator of database synchronization, in step 905, the local database is monitored.

When the initiator of database synchronization identifies that its local database changes in step 910, the initiator selects the synchronization content to be transferred from the local database according to its local control information such as the fine-granularity synchronization content packaging policy in step 915.

Next in step 920, the initiator encapsulates the selected synchronization content as an MMS synchronization package, and assigns a synchronization number to the MMS synchronization package for identifying the sequence and continuity between the MMS synchronization package and other related MMS synchronization packages transferred to the same database synchronization recipient. The MMS synchronization package and its encapsulation may be referred to the above description for the MMS package encapsulating module 221 in conjunction with FIG. 5, which is omitted herein.

In step 925, the initiator of database synchronization sends the above generated MMS synchronization package to the database synchronization recipient through the MMS center. As shown in FIG. 9(b), at the side of the recipient of database synchronization, in step 930, the MMS synchronization package sent by the above initiator of database synchronization through the MMS center is received.

Next, in step 935, the recipient of database synchronization determines whether the synchronization number of the MMS synchronization package is continuous with the synchronization number of the related MMS synchronization package previously received, thus determining whether the reception of the MMS synchronization package is normal. If so, then the process proceeds to step 940, otherwise proceeds to step 950.

In step 940, the recipient of database synchronization parses the received MMS synchronization package to obtain the synchronization content embedded therein. The parsing of MMS synchronization package may be referred to the description for the MMS package parsing module 223 in conjunction with FIG. 5, which is omitted herein.

Next, in step 945, the recipient of database synchronization updates its local database according to the synchronization content.

Next in step 950, the recipient of database synchronization returns a database synchronization status report to the above initiator of database synchronization.

The above is a detailed description of the MMS-based database synchronization method and system of the present invention. As can be seen by a person skilled in the art, the present invention can be embodied as a method, a system and/or a computer program product. So the present invention can be presented in the form of a complete hardware implementation, a complete software implementation, or a combined implementation of software and hardware.

To sum up, the MMS-based database synchronization method and system of the present invention implements database synchronization between a synchronization server and a mobile terminal by using MMS. Its merits can be summarized as follows:
1. Because of the data push function of the multimedia messaging system, the synchronization server has the capability to actively initiate a database synchronization process once data change occurs, thus improving the response speed of the system.
2. For those mobile terminals which do not support VPN client and thus can not access an intranet, by adopting the present invention, they are made to be able to implement database synchronization; in addition, the present invention can save the cost of system deployment and maintenance in terms of device authentication and secure data transmission by taking advantage of the MMS system.
3. By using a telecom carrier's distributed MMS system, the method and system do not need to consider the performance and scalability issues and will be able to achieve better reliability.
4. Thanks to the MMS infrastructure, mobile terminal users do not need to care whether the database synchronization can be successfully finished, and once the data to be synchronized is packaged into an MMS synchronization package, the MMS system guarantees the successful delivery of the data to the right destination.

While the MMS-based database synchronization method and system of the present invention are described in detail with reference to some exemplary embodiments hereinabove, these embodiments are not exhaustive, and a person skilled in the art can implement various changes and modifications within the spirit and scope of the present invention. Therefore, the present invention is not limited to these embodiments and the scope of the present invention is only defined by the attached claims.

What is claimed is:

1. A Multimedia Messaging Service (MMS)-based synchronization server comprising: an MMS synchronization engine connected to a gateway connected to an MMS center, for initiating the delivery of synchronization content to a certain mobile terminal through the MMS center when it is identified that there is a need to:
(a) conduct database synchronization with the mobile terminal;
(b) update a local database in response to the synchronization content sent by the mobile terminal through the MMS center; or
(c) both (a) and (b); and
a synchronization control database for storing control information needed during the database synchronization by the MMS synchronization engine.

2. The MMS-based synchronization server of claim 1, wherein the synchronization control database comprises: an MMS synchronization policy table for recording either or both of the following:
identification information needed for the delivery of the synchronization content to the mobile terminal through the MMS center, initiated by the MMS synchronization engine; or
a synchronization content packaging policy applied in the delivery of the synchronization content to the mobile terminal through the MMS center, initiated by the MMS synchronization engine,
wherein the MMS synchronization engine acquires the synchronization content to be transferred according to the synchronization content packaging policy corresponding to the certain mobile terminal when it is identified that there is a need to conduct database synchronization with the mobile terminal.

3. The MMS-based synchronization server of claim 2, further comprising: an MMS administrator console through which at least one of the following items is set for the MMS synchronization server:
an MMS-related system configuration;
an MMS-related data subscription; and
the synchronization content packaging policy in the MMS synchronization policy table.

4. The MMS-based synchronization server of claim 2, wherein the identification information needed for the delivery of the synchronization content to the mobile terminal through the MMS center includes device identification assigned to the MMS-based synchronization server by the MMS center or by a mobile phone operator.

5. The MMS-based synchronization server of claim 2, wherein the synchronization content packaging policy applied in the delivery of the synchronization content to the mobile terminal through the MMS center includes a fine-granularity synchronization content packaging policy of a selection rule for the synchronization content to be transferred, preset with respect to the mobile terminal.

6. The MMS-based synchronization server of claim 1, further comprising: a synchronization channel-selecting and conflict-detecting module for detecting available synchronization channels between the MMS-based synchronization server and the mobile terminal capable of:
determining whether the MMS synchronization engine conducts the MMS-based database synchronization according to a predetermined channel selection policy; and
detecting and solving a synchronization conflict due to a plurality of available synchronization channels.

7. A Multimedia Messaging Service (MMS)-based synchronization gateway comprising:
an MMS synchronization gateway controller interfaced with a synchronization server, for either or both of the following:
receiving from the synchronization server synchronization content to be sent to a mobile terminal; or
sending to the synchronization server a synchronization content coming from the mobile terminal through the MMS center;
an MMS packet encapsulating module for encapsulating the synchronization content received from the synchronization server by the MMS synchronization gateway controller and to be sent to the mobile terminal as an MMS synchronization package;
an MMS package sending/receiving module connected to the MMS center via an MMS channel, for either or both of the following:
sending to the mobile terminal through the MMS center the MMS synchronization package generated by the MMS packet encapsulating module; or
receiving from the MMS center the MMS synchronization package coming from the mobile terminal; and
an MMS package parsing module for parsing the MMS synchronization package coming from the mobile terminal and received by the MMS package sending/receiving module from the MMS center, the MMS package parsing module being capable of obtaining the synchronization content therein and sending it to the synchronization server via the MMS synchronization gateway controller.

8. The MMS-based synchronization gateway of claim 7, wherein the MMS package encapsulating module is capable of assigning a synchronization number to each of a plurality of related MMS synchronization packages to be sent to the same mobile terminal.

9. The MMS-based synchronization gateway of claim 7, wherein the MMS package encapsulating module is capable of:
determining the type of the synchronization content and inserts it into the corresponding type of message content part of an MMS message;
inserting an address of the synchronization server and an address of the mobile terminal into source address and the destination address fields of the MMS message, respectively; and
in the MMS message, indicating that the MMS message is an MMS synchronization package.

10. The MMS-based synchronization gateway of claim 7, wherein the MMS package parsing module is capable of:
parsing out the synchronization content from the MMS synchronization package;
parsing out the source address and the destination address from the MMS synchronization package; and
sending the synchronization content, the source address, and the destination address to the synchronization server through the MMS synchronization gateway controller, respectively.

11. A Multimedia Messaging Service (MMS)-based mobile terminal comprising:
an MMS client agent for sending and receiving an MMS message; and
an MMS synchronization agent for initiating the deliver of synchronization content to a synchronization server through an MMS center when it is identified that there is needed to:
(a) conduct database synchronization with the synchronization server;
(b) update a local database in response to an MMS synchronization package for database synchronization sent from the synchronization server through the MMS center; or
(c) both (a) and (b).

12. The MMS-based mobile terminal of claim 11, wherein the MMS synchronization agent comprises:
an MMS synchronization package identifying module for identifying whether the MMS message received through the MMS client agent is an MMS synchronization package;
an MMS package parsing module for parsing out the synchronization content embedded in the MMS synchronization package;
an MMS synchronization engine for either or both of the following:
updating the local database according to the synchronization content parsed out of the MMS synchronization package; or
initiating the delivery of the synchronization content to the synchronization server when it is identified that there is needed to conduct database synchronization with the synchronization server; and
an MMS package encapsulating module for encapsulating the synchronization content to be transferred to the synchronization server through the MMS center as an MMS synchronization package.

13. The MMS-based mobile terminal of claim 11, wherein:
the MMS synchronization package has a synchronization number for identifying the sequence and continuity between the MMS synchronization package and other related MMS synchronization packages sent to the MMS mobile terminal; and
the MMS synchronization agent is capable of determining whether the local database synchronization status is normal according to the synchronization number.

14. The MMS-based mobile terminal of claim 13, wherein the MMS package encapsulating module is capable of:
determining the type of the synchronization content and inserting it into the corresponding type of message content part of an MMS message;
inserting the address of the synchronization server and the address of the mobile terminal into the source address and the destination address fields of the MMS message, respectively; and
in the MMS message, indicating that the MMS message is an MMS synchronization package.

15. The MMS-based mobile terminal of claim 14, wherein the MMS synchronization agent further comprises:
a status reporting module for generating a synchronization status report for reporting to the synchronization server the local database synchronization status of the MMS mobile terminal,
wherein the MMS package encapsulating module is capable of encapsulating the synchronization status report as a synchronization status report package.

16. A Multimedia Messaging Service (MMS)-based database synchronization method comprising:
encapsulating, by an initiator of database synchronization, the synchronization content needed to be delivered to a recipient of database synchronization for conducting database synchronization as an MMS synchronization package; and
sending, by the initiator of database synchronization, the MMS synchronization package to the recipient of database synchronization through an MMS center.

17. The MMS-based database synchronization method of claim 16, wherein, before the encapsulating step the method further comprises:
acquiring the synchronization content to be packaged according to a synchronization content packaging policy preset with respect to the recipient of database synchronization.

18. The MMS-based database synchronization method of claim 16, wherein the encapsulating comprises:
assigning a synchronization number to each of a plurality of related MMS synchronization packages to be sent to the recipient of database synchronization, for identifying the sequence and continuity among the plurality of related MMS synchronization packages.

19. The MMS-based database synchronization method of claim 16, wherein encapsulating comprises:
determining the type of the synchronization content and inserting it into the corresponding type of message content part of an MMS message;
inserting the address of the initiator of database synchronization and the address of the recipient of database synchronization into the source address and the destination address fields of the MMS message, respectively; and
in the MMS message, indicating that the MMS message is an MMS synchronization package.

20. A Multimedia Messaging Service (MMS)-based database synchronization method, comprising:
receiving, by a recipient of database synchronization, an MMS synchronization package containing synchronization content from an initiator of database synchronization through an MMS center; and
updating, by the recipient of database synchronization, a local database according to the synchronization content in the MMS synchronization package.

21. The MMS-based database synchronization method of claim 20, further comprising:
determining, by the recipient of database synchronization, whether its local database synchronization status is normal according to the synchronization numbers of a plurality of related MMS synchronization packages indicating the sequence and continuity thereof, to feed back to the initiator of database synchronization.
